(19) United States
(12) Patent Application Publication
(10) Pub. No.: US 2015/0116652 A1
(43) Pub. Date: Apr. 30, 2015

(54) PORTABLE AND ADJUSTABLE FAN FOR EYEWEAR

(71) Applicant: Joseph Bidinot, Barrie (CA)

(72) Inventor: Joseph Bidinot, Barrie (CA)

(21) Appl. No.: 14/068,348

(22) Filed: Oct. 31, 2013

(51) Int. Cl. G02C 11/08

(52) U.S. Cl. CPC G02C 11/08; G02C 2200/22
USPC 351/62

(57) ABSTRACT

The present invention prevents fogging of eye glasses by circulating air behind the lenses of the glasses, thereby removing the humidity that builds up between the eyes and the glasses. This invention is a device that incorporates an attachment clip to be attached to a hat or other head or face gears, a set of miniature fans to create airflow onto a lens of eyewear to prevent fogging, a set of arms to connect the fans to the clip and to orient the fans at the desired location, a power source, which can be a battery unit, operable to power the fans, and a control switch. The arms are made of a specific type of movable tubing that can be easily moved into position and stay in that position based on facial structure of the glasses.

### FIELD OF THE INVENTION

The present invention relates to a portable and adjustable fan(s) for eyeglasses by circulating air behind the lens, and therefore, removing humidity and condensed air that builds up between the eye and glasses.

### BACKGROUND OF THE INVENTION

Eye glasses may fog up by changes in temperature and can hinder the vision and therefore the health and safety of other individuals. Fogging occurs because humidity rises in the space confined between the eyewear and the wearer's eye. Moisture condenses on the inner surface of the glass element as the latter is cooled by the outside air below the dew point of the air confined between the glasses and the face of the wearer. The dew point of the confined air constantly varies as the relative humidity and temperature of the air inside the eyewear changes with skin respiration. Anyone who wears any type of glasses, be it sun glasses, safety glasses or prescription vision correcting glasses etc., may experience some degree of fogging in hot and humid environments. Another example would be someone working indoors in an unventilated workplace who is under a higher than normal humidity. As their body temperature rises so does the temperature around their face, this hot air gets trapped behind the glasses and causes the lenses to fog.

The prior art provides several different technique to prevent such an issue. For example, the U.S. Pat. No. 2,099,464 issued to Donald L. Bruner et. al. discloses a goggle assembly for aviators which is non-frosting and non-fogging in character. An air conduit was connected to the goggle to provide pre-heated air into the eye cup frame of the said goggle. The goggle should be pre-designed to accept an air conduit into an opening inside the eye cup frame. Such a device requires specific goggles to operate and as such cannot be used with different varieties of widely available goggles.

U.S. Pat. No. 2,539,284 issued to Wilfred Thomas discloses a device used by aviators. Said device provided non-fogging goggles with the help of intake and exhaust ports connected to the frame to deliver pre-heated filtered air to the lens of said goggles. The device is complicated in design and inconvenient to use, because it contains too many attachments which are annoying to the wearer of said goggles.

U.S. Pat. No. 3,825,953 issued to Robert Hunter discloses anti-fog goggles. Said goggles include housing for positioning a fan for conducting air into the space between lens of the goggles and the wearer's face. Position and location of said fan is permanent on top of the goggles and it provides a constant airflow in the space between goggles' lens and wearer's face.

U.S. Pat. No. 4,707,863 issued to Joseph R. McNeal discloses anti-fog goggles with a foam frame that have a plurality of air channels in the foam frame to allow air into and out of the interior of the goggles. Said goggles are designed with a cushioning foam with an air channel used to provide anti-fog functionality. The design and configuration on said goggles is complicated and expensive to manufacture.

U.S. Pat. No. 5,363,512 issued to Fred F. Grabos et al. discloses protective goggles that have ventilated lens mounted in the frame. The ventilated lens provides air flow to the space in the interior of the goggles. These goggles are complicated in design and expensive to manufacture.

U.S. Pat. No. 6,450,639 B1 issued to Carl J. Abraham discloses fog-free protective glasses which have a plurality of apertures that provide continuous air flow between the frame and user's eye. A plurality of airflow apertures which designed in the entire frame, function to allow air circulation from outside the eyewear to enter an area in front of the user's face to prevent fog from forming on the lenses and frame.

U.S. Patent application US 2013/0160195 A1 by James T. Clement discloses a portable fan and battery box for clearing fog in goggles or helmets. The device includes a fan that provides airflow and transfers the airflow by air outlet hoses to the area behind the lenses. Having air outlet hoses attached to the frame is inconvenient to use. Users who wear such an attachment to the frame are not comfortable while wearing such a device.

The prior art also discloses anti-fog coatings and lens treatment for this purpose. These treatments are designed to prevent water vapour from building up on the lens and creating fog. These coatings need to be reapplied very often. Additionally, anti-fog coatings have been found to interfere with vision as they become contaminated. As well, such coatings have not proven to be adequately effective at low temperatures.

The devices in the prior art have been inconvenient to use, they have required an outside or independent source of circulating air, and their attachments are annoying to the wearer and interfere with clear vision. The present invention deals with the humidity and water vapour by directly removing it from the problem area therefore making the build-up of water not possible.

### SUMMARY OF THE INVENTION

The present device prevents the user's eyeglasses from fogging by circulating air behind the lenses of the glasses, thereby removing the humidity that builds up between the eyes and the glasses. This invention is a device that incorporates an attachment clip used to attach the device to a hat or other head or face gear, a power source which can be a battery unit providing power to the fan(s) unit, a switch and a fan(s) to create airflow onto the lens of eyewear to prevent fogging. The fan(s) or air ducts are mounted to a specific type of movable stay put tubing that can be easily moved into position and will remain in that desired position. The fans could also be mounted to a ball and socket type joint or any other movable joint assembly to accomplish the same effect with which the user can efficiently direct the airflow where needed based on the facial structure of the glasses themselves.

The first objective of the present invention is to provide a device which does not interfere with the configuration of the glasses. The user can at any time use the anti-fog fan device with his/her glasses or have it removed. The present invention provides airflow to the back of the lenses of the glasses without touching the frame of the glasses.

The second objective of the present invention is to provide a miniature anti-fog device which is quite with minimal noise. Such devices can be used by hunters without disturbance and without generating distraction during hunting. This objective is achieved by eliminating any air ducting and directly bowing air towards the glasses using miniature fans located close to the glasses.

The third objective of the present invention is to locate the fans close to the eyeglasses. In order to use miniature fans for quite operation, they have to be positioned very close to the eye glasses, otherwise, miniature fans would not have enough air flow to remove fog. Therefore, the present device is designed such that they miniature fans can be located close to the eyeglasses.

The fourth objective of the present invention is to provide a device which is portable and can be easily installed on and removed from a hat of a user. The present invention is a lightweight device, which can be handled by any person without causing any inconvenience.

The fifth objective of the present invention is to provide a device that can operate hands-free. The user can remove fog from the glasses without having to touch the glasses. For example, the users who are wearing the present invention do not have to concern themselves with removing the glasses and wiping away fog when their hands are not clean or being used.

The sixth objective of the present invention is to provide a device which is easy to manufacture and inexpensive so the users can use the present invention with any kind of glasses.

The seventh objective of the present invention is to provide a device which is more comfortable to wear. Workers or hunters who need the device because they are working in a specific environment can wear the device comfortably. The present invention does not affect their vision negatively.

The eight objective of the present invention is to provide a device which has flexible fans to create airflow behind the lenses of the glasses. These flexible fans can be placed at a specific zone according to the user's preference and based on the user's expectation.

The object features and effects of the invention are described in details below with accompanied drawings and embodiments. The aforementioned objects of the present invention are attained by a device and method that functions for anti-fog purposes. Other objects, advantages and novel features of the present invention will become readily apparent from the following drawings and detailed description of preferred embodiments.

### BRIEF DESCRIPTION OF THE DRAWINGS

Embodiments herein will hereinafter be described in conjunction with the appended figures provided to illustrate and not to limit the scope of the claims, wherein like designations denote like elements, and in which:

FIG. 1 is a perspective view of an adjustable fan for eyeglasses;

FIG. 2 is a perspective view of the base from the side that stores battery or other energy sources;

FIG. 3 is a side elevation view of the adjustable fan for eyeglasses;

FIG. 4 shows a side plan view of the adjustable fan for eyeglasses when a user wears it with a baseball hat;

FIG. 5 shows a side plan view of the adjustable fan for eyeglasses when a user wears it with a classic hat;

FIG. 6 shows a side plan view of the adjustable fan for eyeglasses when a user wears it with a hard hat;

FIG. 7 shows a side plan view of the adjustable fan for eyeglasses with air flow direction; and

FIG. 8 shows the adjustable fan for eyeglasses which is installed on a cap, and interfaces with the use of software on a hand held device by user.

### DETAILED DESCRIPTION OF PREFERRED EMBODIMENTS

The following is detailed description of the drawings which show exemplary embodiments of the present portable and adjustable fan for eye glasses to prevent them from fogging. The present invention removes the humidity that builds up between the eyes and eyewear, by circulating air behind the lens.

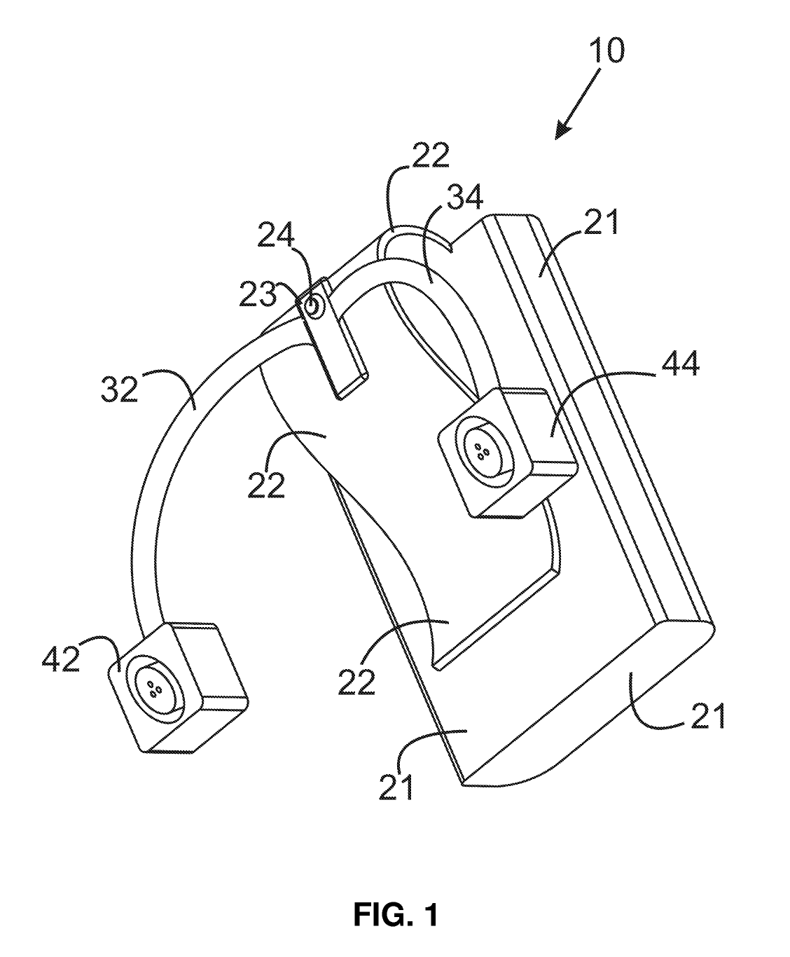

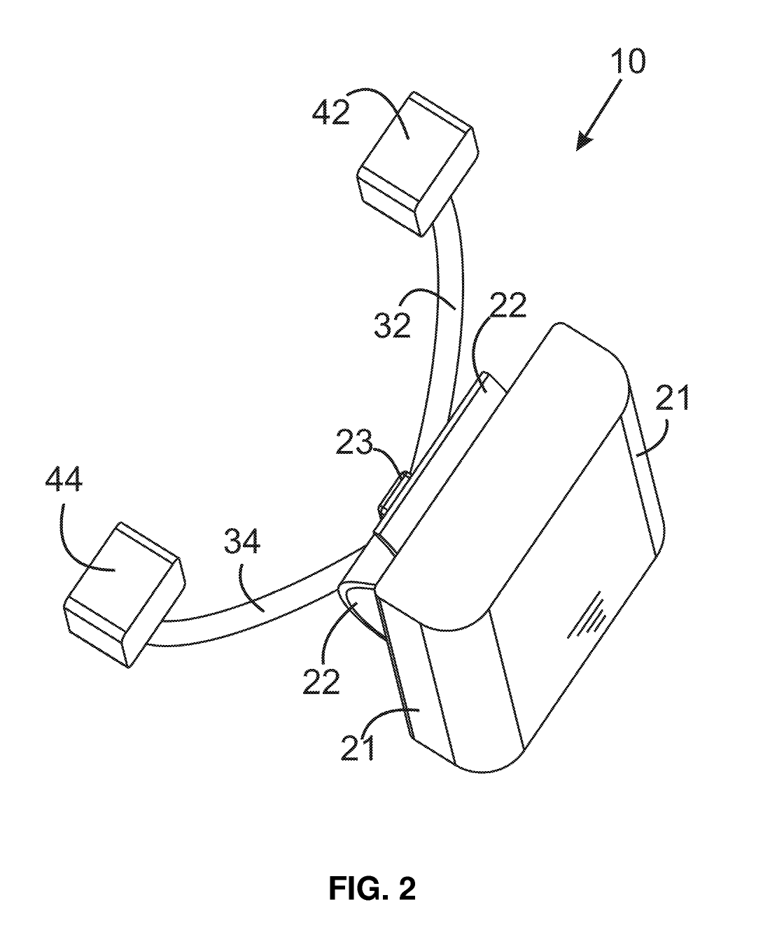

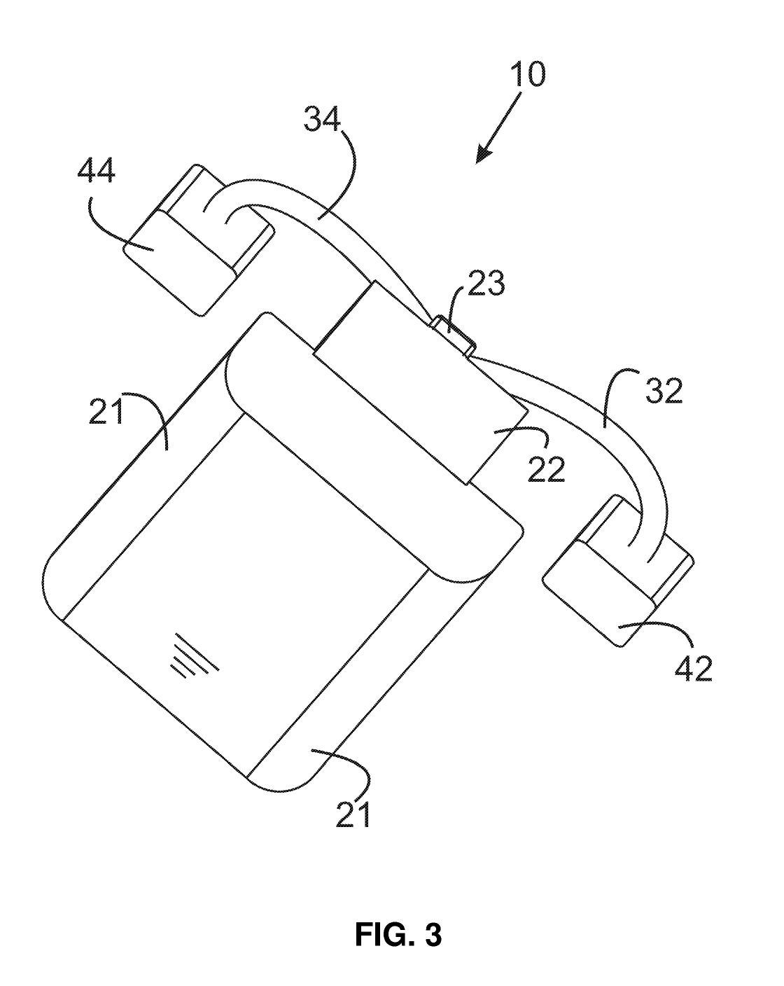

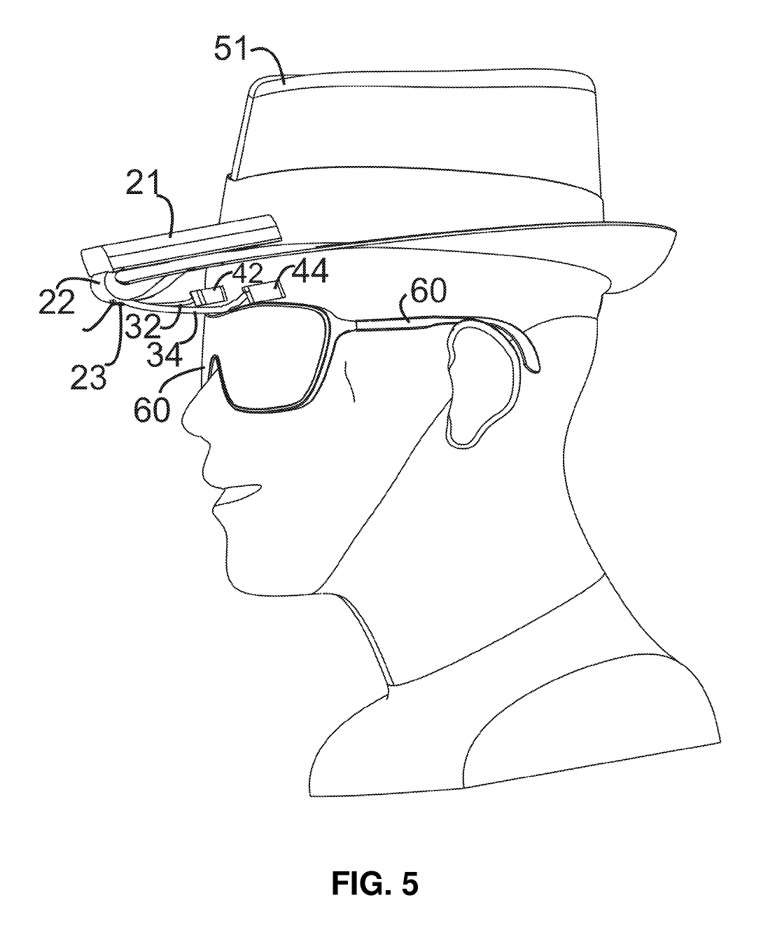

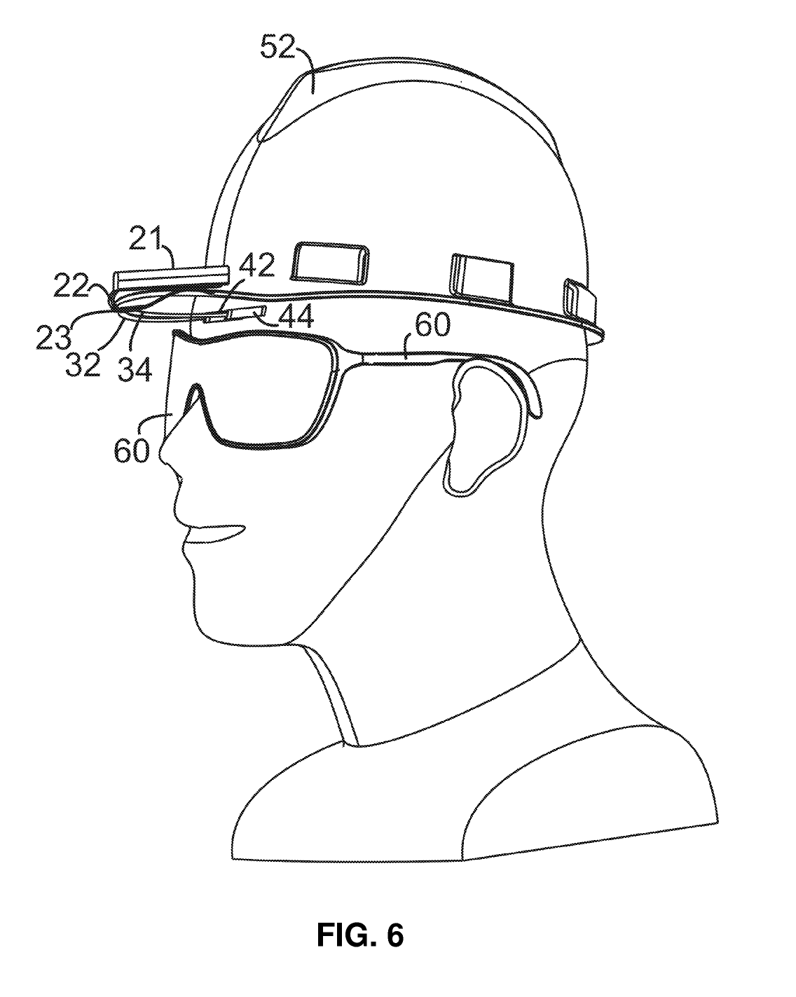

Referring to FIG. 1-6, an anti-fogging device 10 is shown; the base plate 21 has a leg 22 that is attached to a hat 50, 51, 52 or any comparably formed items. The base plate 21 contains a power box which is used to house batteries to supply power to the fans. The base plate 21 is integrally built in at least one leg 22 to engage the device 10 to a hat 50 or any comparable formed items.

The base plate 21 and the leg 22 function as a spring clip that is to be engaged by a hat 50. They can be formed integrally together or be connected by some screws or glued to one another. The shape of the spring clip can vary in order to provide the functionality of engaging said device 10 to said hat 50.

The arm(s) 32, 34 are connected to a control switch 23 from one end and to the fan(s) 42, 44 on the other side. The arms 32, 34 carry wires from a control switch 23 to said fans 42, 44. The arm 32 is comprised of a specific type of movable tubing that can be easily moved into position and will stay in that position to provide precise location of airflow which is produced by said fan(s) 42,44.

The control switch 23 controls said fans 42, 44 by turning them on and off. It also provides different speed for fans 42, 44 for operation in different air humidity. The user can select the speed of the fans 42, 44 based on his/her expectation. An on-off button 24 turns the fans 42, 44 on at a specific speed. If the speed of the fans is not adequate to prevent fogging behind the lenses of the glasses 60, the user can easily change the speed of the fans 42, 44.

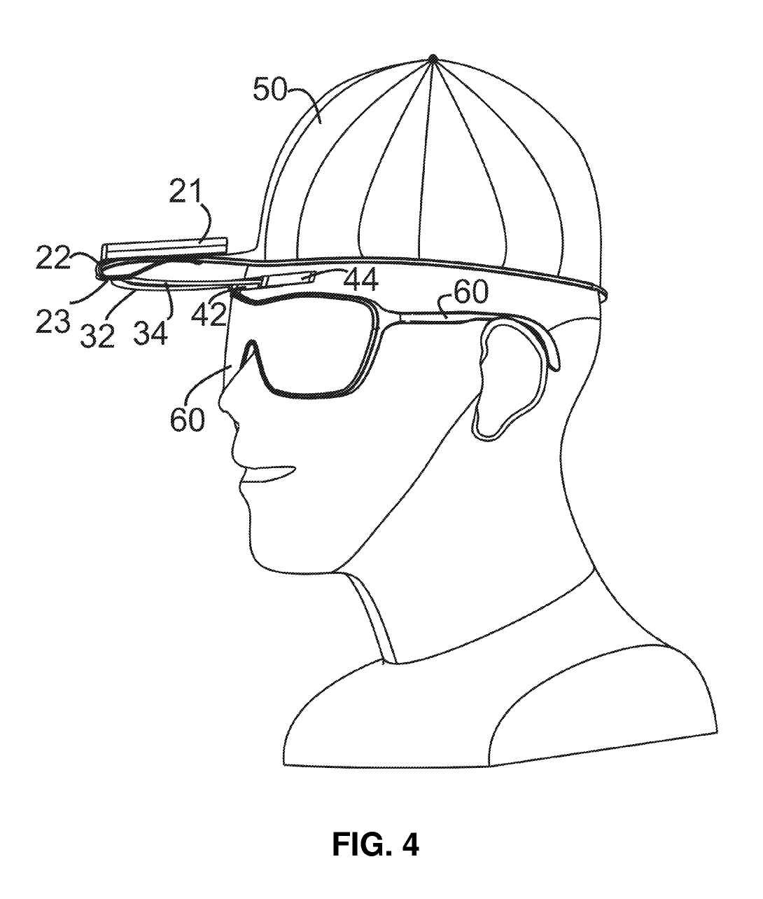

Referring to FIGS. 4, 5, 6 and 7, adjustable fans 42, 44 can be mounted on the hat 50, 51, 52 or other head wearing with said spring clip and the stream of air can be provided to prevent the glasses 60 from fogging. On the other side, the present invention prevents the creation of significant airflow around the glasses into the eyes by using adjustable fan(s) 42, 44. The adjustable fans 42, 44 can be placed in a desirable place based on the glasses configuration and the height of the forehead of the user. The orientation of said fans 42, 44 can be adjusted by the movable arms 32, 34 in order to provide a steady airflow 72 behind the glasses 60 to prevent fogging.

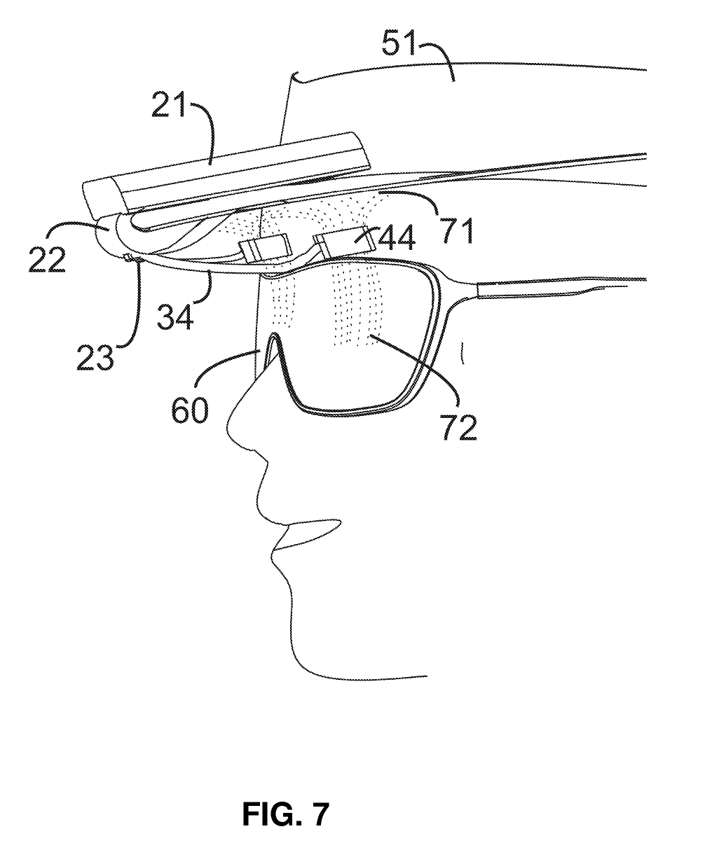

Referring to FIG. 4-7, the arm(s) 32, 34 are completely adjustable to a position which is comfortable for user. One of the advantages of the present invention is the ability to control the pressure of the airflow and conduct arm to the correct location by having such said arms 32, 34. Another objective of the present invention is to provide an adequate airflow 72 through the glasses 60 to counteract the building of condensation upon the interior surface of the eye glasses 60 by using small fans 42, 44. Referring to FIG. 7, the fans 42, 44 circulate the air 71 above the glasses 60 and create airflow 72 behind the lenses of glasses 60 to prevent fog.

Again referring to FIG. 4-7, the present invention can be used one a baseball hat 50, or a classic hat 51, or in a work place on a hard hat 52. The size of the power box can be changed by improving in battery manufacturing. It may also have other forms of power supply than batteries. It also can be made by a metal material or plastic material based on the environment application.

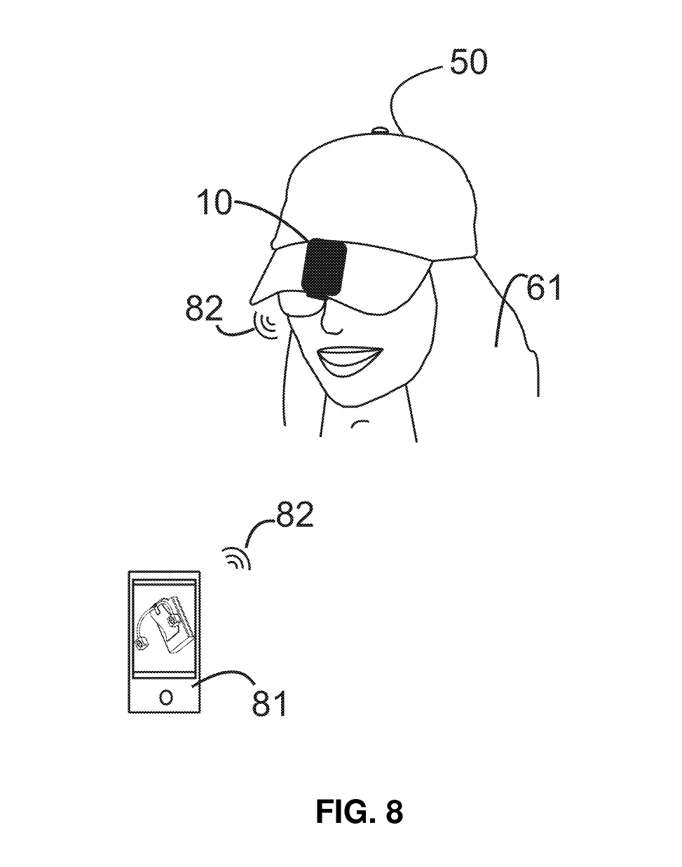

In one embodiment of the present invention as shown in FIG. 8, the device 10 is installed on a cap 50, and can interface with the use of software on a PC (not shown) or a hand held device 81 or a smartphone 81 by user 61. The device 10 is connected to a mobile phone 81 with Wi-Fi or Bluetooth connection 82 to control the speed of fans, and the direction of rotation (clockwise or counter clockwise). The device can also be programed by a mobile phone 81 to control the period of the time that it is on or off based on user's expectation.

In another embodiment of the present invention, the power box and control switch can be embodied into a hat or any comparably formed items. In this case, the adjustable arms and fans can be seen from the cap of the hat or any other clothing worn on the head.

In the present invention, attachment assembly preferably includes a base and a deformable clasp preferably has slightly arcuate configuration. In another embodiment of the present invention, the clip can be a hinge or similarly shaped to function for engaging the said device to a hat or any other clothing worn on the head.

In another embodiment of the present invention, the arms can be retractable to provide different length for better functionality of the fans. It also can be designed to have a telescopic length.

In another embodiment of the present invention, the arms can be in ball and joint design to provide different movement from left to right and up and down to locate the fans in a specific location for providing steady air flow behind the lenses. It also can be designed to contain a plurality of hinges to provide exact functionality for the fans.

Having described and illustrated the principles of this application it should be apparent that the preferred embodiments may be modified in arrangements and detail without departing from the principles disclosed herein.

A variety of methods can be used to manufacture the adjustable fans device. One method being by injection molding, wherein whole parts of the said device can be mold integrally. The material to form the adjustable fans device can be plastic or any other material commonly used to manufacture similar products.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A portable and adjustable anti-fog device for eyeglasses to prevent and remove fog on a lens comprising two miniature fans, each said fan being attached to one end of a flexible arm, the other end of said flexible arms being attached to a holder, and a power source to power said fans, whereby, each said fan can be aligned on the top of each lens of an eyeglasses to blow air directly behind the glasses.

2. The portable and adjustable device of claim 1, wherein said holder being a spring clip comprising a first portion as a base plate to engage to the power source and at least one second portion as a leg integrally formed with said first portion disposed on the base plate, wherein the second portion being formed to exert a clamping function.

3. The portable and adjustable device of claim 2, wherein said spring clip is composed of a metal or a plastic material.

4. The portable and adjustable device of claim 1, wherein said flexible arms comprise of flexible tubes having a channel to carry a plurality of wires from the power box to said fans.

5. The portable and adjustable device of claim 1, wherein said flexible arms being telescopic to provide different length.

6. The portable and adjustable device of claim 1, wherein said flexible arms comprise of a plurality of hinges to provide different angles for said fans.

7. The portable and adjustable device of claim 1, wherein said flexible arms being ball and joint connection.

8. The portable and adjustable device of claim 1, wherein said miniature fans having speed control to control the flow of air.

9. The portable and adjustable device of claim 1, further having a control switch to control the speed of said fans, direction of rotation of said fans and period of time for turning the device ON or OFF.

10. The portable and adjustable device of claim 9, wherein said control switch being programed by a handheld device or a computer to control the speed of said fans, direction of rotation of said fans and period of time for turning the device ON or OFF.

11. The portable and adjustable device of claim 10, wherein said anti-fog device being connected to said handheld device through Wi-Fi or by wire.

12. The portable and adjustable device of claim 1, wherein said source having batteries being in any size and shape.

13. The portable and adjustable device of claim 11, wherein said battery being a rechargeable battery.

14. The portable and adjustable device of claim 1, wherein said power source and said control switch being embodied to a hat or a headband or comparable items.

15. A portable and adjustable device for an eye glasses to prevent fog to a lens comprising:
a. a plurality of retractable, resilient, flexible arms having distal and proximal ends;
b. a plurality of small fans being connected to said arms from the distal end, said fans being aligned above the eyeglasses to blow air to the region between the eyes and the eyeglasses;
c. a control switch to control said fans and being connected to said fans through said arms;
d. a power box to keep plurality of batteries for supplying power to said control switch and said fans; and
e. a spring clip for connecting said device to a hat or comparable head wear items.
